(19) United States
(12) Patent Application Publication
(10) Pub. No.: US 2007/0049366 A1
(43) Pub. Date: Mar. 1, 2007

(54) Threshing tine for a combine rotor

(76) Inventor: Glenn Everett Pope, Viola, IL (US)

Correspondence Address: DEERE & COMPANY, ONE JOHN DEERE PLACE, MOLINE, IL, 61265, US

(21) Appl. No.: 11/213,119

(22) Filed: Aug. 26, 2005

(51) Int. Cl. A01F 12/00

(52) U.S. Cl. 460/68

(57) ABSTRACT

A method and apparatus for use in a combine rotor for processing harvested agricultural crop, the threshing section of the combine rotor having one or more threshing tines, each threshing tine having multiple crop engaging portions that project upwardly and forwardly from the rotor, each crop engaging portion having a threshing surface on a front face thereof, and at least one groove running generally diagonally across the front face of the crop engaging portion for moving material through the combine rotor more efficiently.

### FIELD OF THE INVENTION

The present invention is directed to a combine used for crop harvesting that utilizes a threshing assembly to separate the grain from the other plant material as the crop is being harvested in the field. In particular, the present invention is directed to a combine rotor having threshing tines on at least a portion of the threshing drum.

### BACKGROUND OF THE INVENTION

Agricultural combines are large machines that harvest, thresh, separate and clean an agricultural crop bearing grain. The resulting clean grain is stored in a grain tank located on the combine. Rotary combines have one or two large rotors for threshing and separating the harvested crop material. In most rotary combines the rotor or rotors are arranged along the longitudinal axis of the machine. These rotors are provided with an infeed section for receiving crop material from the field, a threshing section of the drum for threshing the harvested crop material received from the infeed section and a separating section for freeing grain trapped in the threshed crop material received from the threshing section. During rotation of the rotor, the crop is moved longitudinally from the infeed section through the threshing section of the rotor to the separating section. Rotors are provided for combines in a variety of configurations to optimize harvesting efficiency for a wide variety of crops and crop conditions. Similarly, the types, number and arrangement of threshing tines used vary, and are selected to optimize harvesting efficiency, depending on the type of crops being harvested.

In certain crop conditions, especially those having high yield and a large amount of crop material other than grain, the rotor can slow or hesitate as it struggles to process the crop. These changes in performance in the combine rotor result in grain loss due to inefficient crop processing, and increased distress of the combine due to changes in system speed and abrupt changes in power consumption.

### SUMMARY OF THE INVENTION

The present invention is for a combine rotor having tines in the threshing section that incorporate multiple crop engaging portion structures and have a threshing surface on the same part. The threshing tine of the present invention has more than one crop engaging portion thereon, and the crop engaging portions also have a sloped face that incorporates a threshing surface thereon. Additionally, the threshing tine of the present invention incorporates a directional set of grooves on the crop engaging portions for moving the crop along the axis of the rotor. The threshing tine of the present invention improves material movement through the threshing rotor, especially with heavy crops and/or those having a high yield. In some arrangements, the tines additionally have a tapered shape to aid in crop mat penetration. Additionally, the threshing tine of the present invention helps break up and separate grain and crop material other than grain more efficiently.

The present invention is for a threshing tine for use on an axial crop processing unit in an agricultural harvester, the threshing tine comprising a base having through-material holes for securing the threshing tine to a drum in the axial crop processing unit by securing means, at least two spaced-apart crop engaging portions secured to the base, the crop engaging portions having a front face curved upwards from the base and backwards toward a rear of the base, the front face of the crop engaging portions having a threshing surface thereon; and the front face of the crop engaging portions having at least one groove thereon, the groove running generally diagonally across the front face of the crop engaging portions.

Another arrangement of the present invention is for use in an agricultural harvester having an axial crop processing unit having a rotor comprising a drum having a front frusto-conical portion, and a rear cylindrical portion adjacent to the frusto-conical portion; the rotor having an infeed section having at least one helical infeed element being located on a fore-region of the frusto-conical portion of the drum, a threshing section for processing harvested crop material received from the infeed section of the rotor, threshing section having at least one threshing tine, the threshing tine having multiple crop engaging portions curving upward and rearward from the rotor, each crop engaging portion having a threshing surface and at least one groove running diagonally across the face thereof, and a separating section having at least one separating finger being located on the rear region of the cylindrical portion of the drum.

Yet another arrangement of the present invention is for a method of processing an agricultural crop in an agricultural crop harvesting machine, the method comprising the steps of harvesting a grain-bearing crop from the soil, directing the harvested crop to an axial crop processing unit at least partially contained in the agricultural crop harvesting machine, feeding the crop between a housing and an infeed section of a rotor in the axial crop processing unit, said infeed section engaging the harvested crop and directing the harvested crop toward a threshing section of the rotor, threshing the harvested crop in the threshing section of the axial crop processing unit to separate the grain from the crop, the threshing section having at least one threshing tine, each threshing tine having multiple crop engaging portions having a threshing surface on a front side thereof for threshing the grain from the harvested crop, the multiple crop engaging portions breaking up clumps of harvested crop, the crop engaging portions having diagonal grooves across the front face thereof for directing harvested crop through the axial crop processing unit; and the threshing section directing the threshed crop toward a separating section of the axial crop processing unit, the separating section having at least one separating finger secured to the rotor for separating the grain from the harvested crop and directing the remainder of the harvested crop out of the rear of the axial crop processing unit.

### BRIEF DESCRIPTION OF THE DRAWINGS

FIG. 1 is a partial cross-sectional side view of a rotary agricultural combine;

FIG. 2 is a perspective view of a rotor incorporating threshing tines of the present invention;

FIG. 3 is a partial perspective view of a portion of a rotor that incorporates the threshing tines of the present invention; and

FIG. 4 is a perspective view of a threshing tine of the present invention.

### DETAILED DESCRIPTION

In the discussion of the FIGURES the same reference numerals will be used throughout to refer to the same or similar components. In the interest of conciseness, various other components known to the art, such as computer processing and storage mechanisms and the like necessary for the operation of the invention, have not been shown or discussed, or are shown in block form.

In the following, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning computer operation and the like have been omitted inasmuch as such details are not considered necessary to obtain a complete understanding of the present invention, and are considered to be within the knowledge of persons of ordinary skill in the relevant art. While the preferred embodiments disclosed herein address land-based vehicles, it can be appreciated that those skills in the art can extend the use of the invention to air or sea vehicles without departing from the scope of the invention disclosed herein.

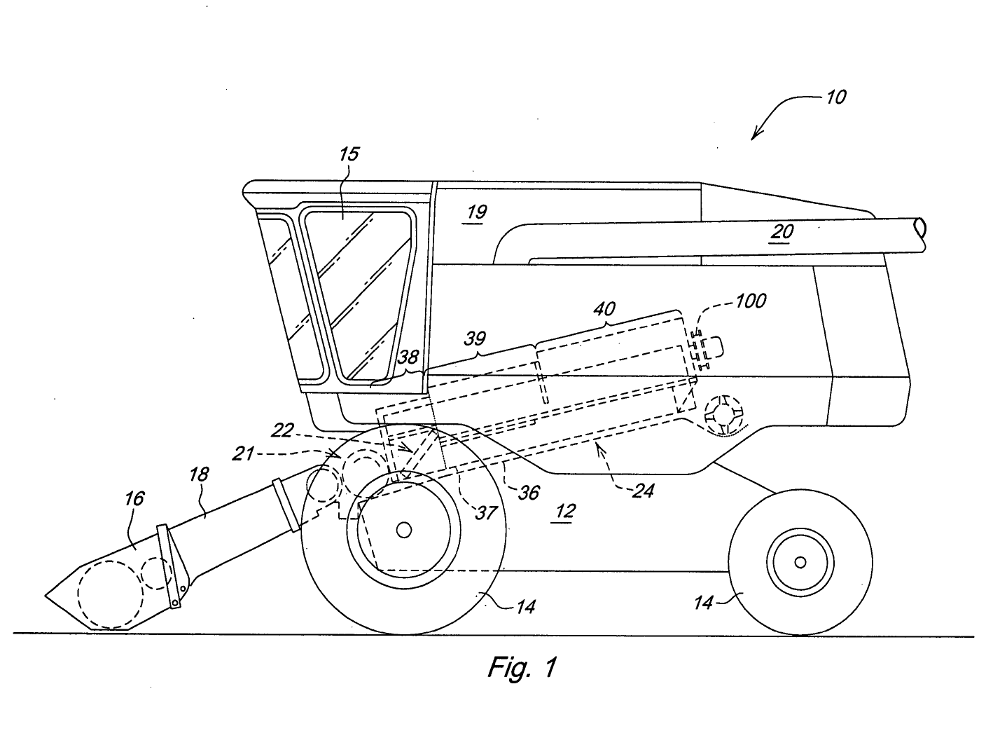

FIG. 1 shows an agricultural combine 10 comprising a supporting structure 12 having ground engaging wheels 14 extending from the supporting structure. The operation of the combine is controlled from the operator's cab 15. A harvesting platform 16 is used for harvesting a crop bearing grain and directing it to a feederhouse 18. The harvested crop is directed by the feederhouse 18 to a beater 21. The beater 21 directs the crop through an inlet transition section 22 to the axial crop processing unit 24. The axial crop processing unit 24 threshes and separates the harvested crop material. Additional cleaning may occur downstream from the axial crop processing unit 24. Ultimately, the clean grain is conveyed into the grain tank 19, and can be conveyed out of the grain tank by means of an auger 20. Threshed and separated crop material other than grain is ultimately discharged through a discharge unit (not shown) and deposited on the ground behind the combine 10.

The axial crop processing unit 24 comprises a rotor housing 36 and a rotor 37 located inside the housing 36. The rotor 37 comprises a drum 100 to which crop processing elements for the infeed section 38, threshing section 39, and separating section 40 are affixed. The infeed section 38 is at the front of the axial crop processing unit 24. Longitudinally downstream and rearward from the infeed section 38 are threshing section 39 and separating section 40. The portion of the drum 100 for the infeed section 38 is typically frusto-conical in shape, extending rearwardly toward the threshing section 39 of the drum 100, although it can also be cylindrical in shape. The threshing section 39 can also be frusto-conical in shape, although in some arrangements of the present invention, the threshing section 39, has a front portion which is frusto-conical in shape, and a rear portion which is cylindrical in shape. The rear portion of the axial crop processing unit 24 is comprised of the separating section 40 of the drum 100, which is cylindrical in shape.

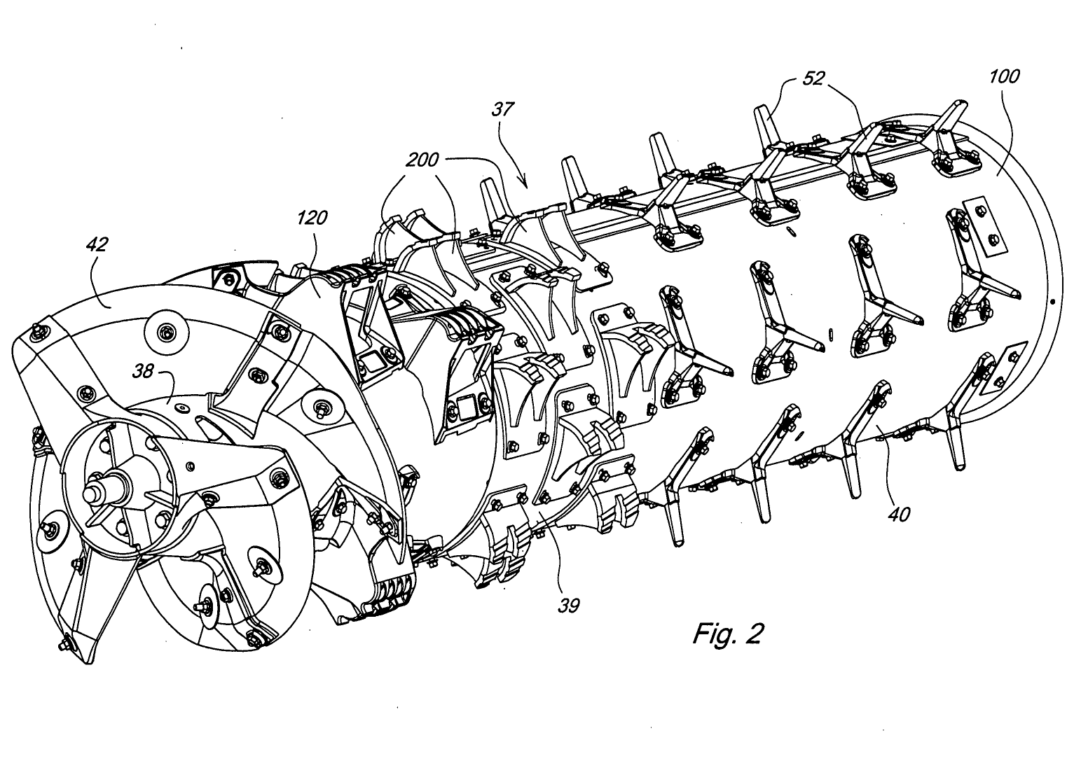

As shown in FIG. 2, the infeed section 38 of the rotor 37 is provided with helical infeed elements 42 to engage harvested crop material received from the beater 21. Immediately downstream from the infeed section 38 is the threshing section 39 of the axial crop processing unit 24. The threshing section 39 of the axial crop processing unit 24 is provided with a number of threshing elements 120, 200 for threshing the harvested crop material received from the infeed section 38. Rearward of the threshing section 39 is the separating section 40. In the separating section 40, the grain which has been threshed and broken loose in the threshing section 39 is separated from the crop material other than grain by means of separating fingers 52, which lift and separate the crop material other than grain away from the grain.

In operation, crop material is fed into the axial crop processing unit 24 from the beater 21 via the inlet transition section 22. The crop material is processed between the helical feed elements 42 on the frusto-conical front section of the rotor 37 and the housing 36 of the axial crop processing unit 24. The impact between the helical feed elements 42 and the housing 36 shatter the grain or seed from the crop material. The shape and curvature of the helical feed elements 42 move the crop material rearward in the direction of the threshing section 39 of the axial crop processing unit 24.

The threshing section 39 provides additional threshing of the crop material by a rubbing action as the crop material is passed between the threshing elements 120, 200 and the housing 36. The unique threshing elements 200 of the present invention are described in greater detail, below. The crop material that has been threshed is then processed further rearward toward the separating section 40 of the axial crop processing unit 24. By this point in the processing, most of the grain has been broken loose from the crop material.

As the crop material is pushed backward into the separating section 40 of the axial crop processing unit 24, the separating fingers 52 separate the crop material other than grain away from the grain itself. The grain is conveyed to the grain tank 19. The crop material may be subjected to further processing to retrieve additional grain that may remain with the crop material, or in some arrangements of combine 10, the crop material other than grain is distributed on to the ground behind the combine 10.

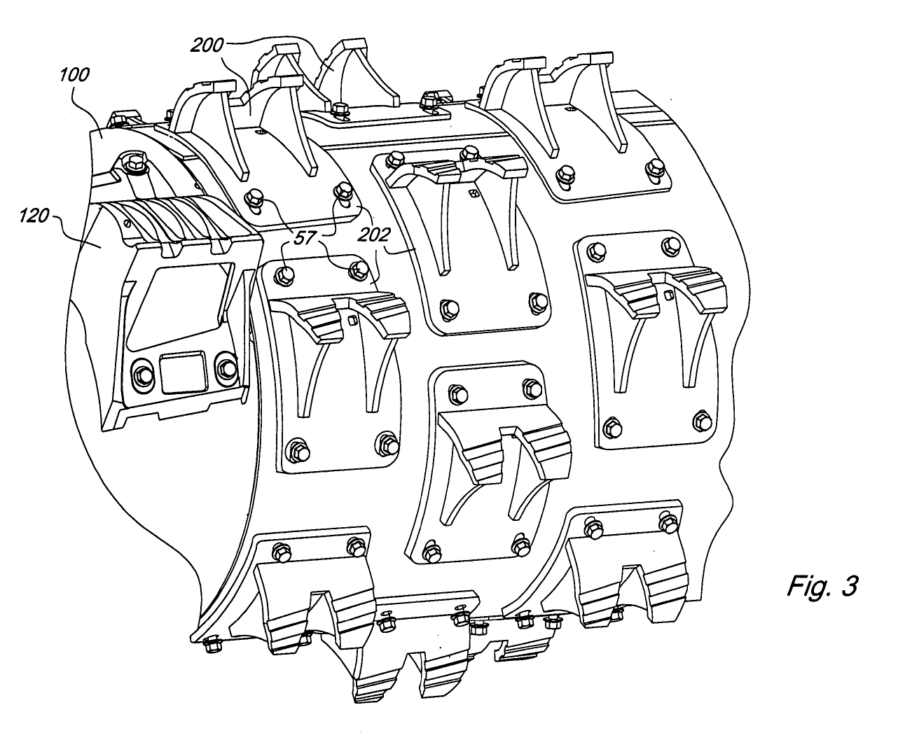

As can be seen in FIGS. 2 and 3, threshing elements 120, 200 are attached to the aft-region of the frusto-conical portion of the drum 100, with optionally, some threshing elements 120, 200 attached to the front of the cylindrical portion of the drum 100. The threshing tines 200 have multiple crop engaging portions 210, each of which incorporates a threshing surface 212 onto the front of the crop engaging portion structure. The crop engaging portions 210 are sloped forward to simulate the shape of the drum 100 and coordinate with the shape of the rotor housing 36. The shape of the crop engaging portions 210 acts to move material rearward on the drum 100. Each threshing tine 200 of the present invention has at least two crop engaging portions 210 thereon, for increased efficiency in moving crop through the axial crop processing unit 24. The use of multiple crop engaging portions 210 on each threshing tine 200 helps to break up clumps of crop material such as that experienced in prior art threshing devices. This helps to prevent uneven feeding and clogging caused by crop material clumps, which can clog or slow crop processing mechanisms.

The threshing tine 200 of the present invention has a base 202 for mounting the threshing tine 200 to the rotor 100. The base 202 is secured to the rotor 100 with mounting bolts 57.

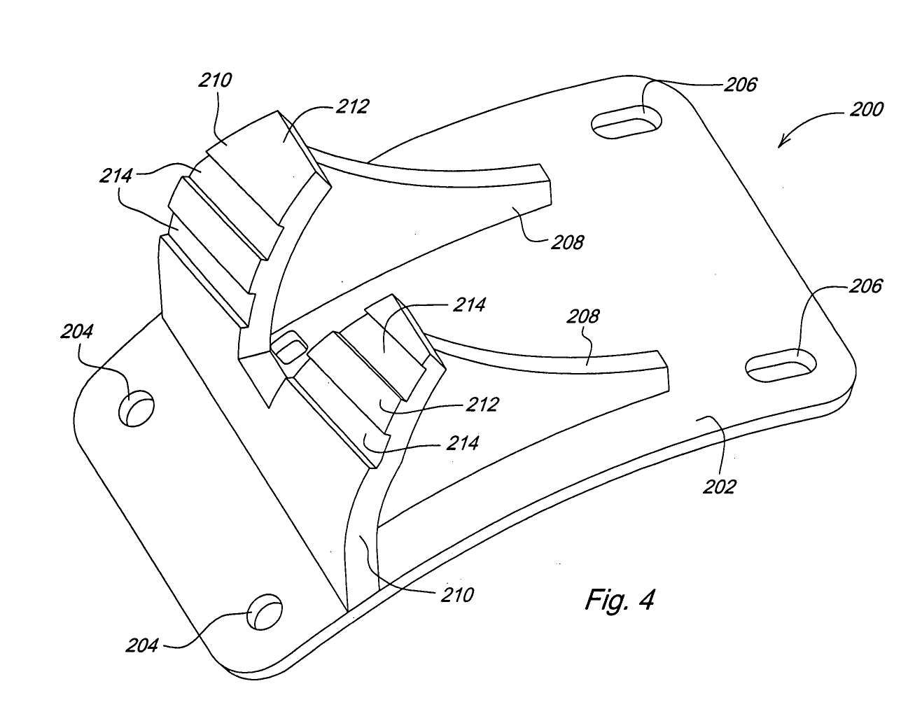

As seen in FIG. 4, the threshing tine 200 of the present invention has a base 202, at least two spaced-apart crop engaging portions 210, and braces 208. The crop engaging portions 210 are secured to the base 202 along the bottom of the crop engaging portions 210. The brace 208 provides additional structural support along the back of the crop engaging portions 210 and along the base 202. In the arrangement of the present invention shown in FIG. 4, the braces 208 are wedge shaped, with two sides thereof being arcuate to reflect the shapes of the rear of the crop engaging portions 210 and the base 202, to which they are joined. The base 202 has mounting holes 204, 206 through which mounting bolts 57 pass for securing the threshing tine 200 to the rotor 100, as seen in FIG. 3.

The crop engaging portions 210 have a threshing surface 212 located on the face thereof for threshing of the crop material between the crop engaging portions 210 and the rotor housing 36. Because the crop engaging portions 210 are curved upward and forward in the direction of rotation of the drum 100, there is a greater surface of contact of the crop material between the rotor housing 36 and the threshing tine crop engaging portions 210, which increases the amount of grain threshed out of the crop material. Additionally, the threshing tine crop engaging portions 210 contain grooves 214 thereon running diagonally along the face of the crop engaging portions 210, in the direction of rotation of the drum 100. These grooves 214 help improve crop material movement through the axial crop processing unit 24.

Additionally, in some arrangements of the present invention, the crop engaging portions 210 are tapered from near a base 202 used to secure the threshing tine 200 to the drum 100, becoming narrower near the upper end of the crop engaging portions 210. This helps to aid in crop mat penetration and further increase threshing efficiency.

The use of multiple tines 200 spread around the threshing portion 39 of the rotor 100, each threshing tine 200 having multiple crop engaging portions 210 helps to smooth out the impact caused by crop clumps and uneven crop feeding. The spacing between the crop engaging portions 210 on a tine 200, and between multiple tines 200, as opposed to a single bar helps to break up the clumps or keep clumps from forming. This aspect of the threshing tines 200, taken in combination with the grooves 214 located across the face of the threshing tine crop engaging portions 210 and the tapered shape of the crop engaging portions 210 helps move crop, especially heavy crop or crop having a large amount of grain therein through the axial crop processing unit 24 while still efficiently threshing the crop.

Depending upon orientation of the grooves 214 on the crop engaging portions 210, processing efficiency or speed of threshing can be improved. The grooves 214 on the surface of the crop engaging portions 210, depending upon the angle at which they are cut across the face of the crop engaging portions 210 can either accelerate crop processing through the threshing portion 39 of the axial crop processing unit 24 (if angled rearward), for reduced power consumption and increased material flow through the separator. Alternatively, if the grooves 214 are angled in the opposite direction, that will make the crop dwell longer in the threshing portion 39 of the axial crop processing unit 24, resulting in improved threshing and separation.

Having described the illustrated embodiment, it will become apparent that various modifications can be made without departing from the scope of the invention as defined in the accompanying claims.

1. In an agricultural harvester having an axial crop processing unit comprising a rotor and a housing, the rotor comprising:
a drum having a front frusto-conical portion, and a rear cylindrical portion adjacent to the frusto-conical portion;
the rotor having an infeed section having at least one helical infeed element being located on a fore-region of the frusto-conical portion of the drum;
a threshing section for processing harvested crop material received from the infeed section of the rotor, threshing section having at least one threshing tine, the threshing tine having multiple crop engaging portions curving upwardly and forwardly from the rotor, each crop engaging portion having a threshing surface and at least one groove running diagonally across the face thereof; and
a separating section having at least one separating finger being located on the rear region of the cylindrical portion of the drum.

2. The rotor of claim 1 having at least one threshing tine located on the cylindrical portion of the drum.

3. The rotor of claim 1 having at least one threshing tine located on the rear-region of the frusto-conical portion of the drum.

4. (canceled)

5. The rotor of claim 1 wherein the groove running diagonally across the face of the threshing surface is oriented downwardly and rearwardly to retain harvested crop material in the threshing section for a greater period of time.

6. The rotor of claim 1 wherein the crop engaging portions are tapered, being larger at an area near the rotor, and becoming narrower away from the rotor.

7. A threshing tine for use on an axial crop processing unit in an agricultural harvester, the threshing tine comprising:
a base having through-material holes for securing the threshing tine to a drum in the axial crop processing unit by securing means;
at least two spaced-apart crop engaging portions secured to the base, the crop engaging portions having a front face curved upwardly from the base and forwardly;
the front face of the crop engaging portions having a threshing surface thereon; and
the front face of the crop engaging portions having at least one groove thereon, the groove running generally diagonally across the front face of the crop engaging portions.

8. The threshing tine of claim 7 wherein the groove running diagonally across the face of the threshing surface is oriented upwardly and rearwardly to process harvested crop material through the threshing section rapidly.

9. The threshing tine of claim 7 wherein the groove running diagonally across the face of the threshing surface is oriented downwardly and rearwardly to retain harvested crop material in the threshing section for a greater period of time.

10. The threshing tine of claim 7 further comprising a brace secured to a rear face of the crop engaging portions and a top of the base for providing additional support to the crop engaging portions of the threshing tine.

11. The threshing tine of claim 7 wherein the crop engaging portions are tapered from the base upwardly.

12. A method of processing an agricultural crop in an agricultural crop harvesting machine, the method comprising the steps of:
harvesting a grain-bearing crop from the soil;
directing the harvested crop to an axial crop processing unit at least partially contained in the agricultural crop harvesting machine;
feeding the crop between a housing and an infeed section of a rotor in the axial crop processing unit, said infeed section engaging the harvested crop and directing the harvested crop toward a threshing section of the rotor;
threshing the harvested crop in the threshing section of the axial crop processing unit to separate the grain from the crop, the threshing section having at least one threshing tine, each threshing tine having multiple crop engaging portions having a threshing surface on a front side thereof for threshing the grain from the harvested crop, the multiple crop engaging portions breaking up clumps of harvested crop, the crop engaging portions having diagonal grooves across the front face thereof for directing harvested crop through the axial crop processing unit; and
the threshing section directing the threshed crop toward a separating section of the axial crop processing unit, the separating section having at least one separating finger secured to the rotor for separating the grain from the harvested crop and directing the remainder of the harvested crop out of the rear of the axial crop processing unit.
